(19) United States
(12) Patent Application Publication
(10) Pub. No.: US 2009/0219435 A1
(43) Pub. Date: Sep. 3, 2009

(54) COMPOSITE LENS AND LENS MODULE HAVING SAME

(75) Inventor: KUN-I YUAN, Tu-Cheng (TW)

Correspondence Address: PCE INDUSTRY, INC.;ATT. Steven Reiss, 458 E. LAMBERT ROAD, FULLERTON, CA, 92835, US

(73) Assignee: HON HAI PRECISION INDUSTRY CO., LTD., Tu-Cheng (TW)

(21) Appl. No.: 12/247,401

(22) Filed: Oct. 8, 2008

(30) Foreign Application Priority Data
Feb. 29, 2008 (CN) 200810300443.7

(51) Int. Cl. H04N 5/225

(52) U.S. Cl. 348/360; 348/E05.024

(57) ABSTRACT

A unitary composite lens includes a body and an optical filter. The optical filter is embedded within the body.

### BACKGROUND

1. Technical Field

The disclosure relates generally to optical elements, and more particularly to a composite lens with an optical filter embedded therein and a lens module having the composite lens.

2. Description of Related Art

Currently, portable electronic devices such as personal digital assistants (PDAs), cellular telephones, and others, with image capture capability are becoming increasingly popular, requiring the deployment of an image capture device in the device.

An image capture device generally consists of a lens module and an image sensor. Light for image formation passes through the lens module and then converges on the image sensor, such as a charge coupled device (CCD) or a complementary metal-oxide semiconductor (CMOS). The image sensor eventually converts analog signals into digital signals for generating an image.

Generally, the image sensor can detect light of spectral range from 380 nm to 1200 nm. However, since the visible light spectrum ranges from 390 nm to 760 nm, the image sensor receives not only visible light but also unwanted infrared light. If the infrared light is not filtered, the final image is flawed thereby. Thus, an infrared (IR) cut filter is usually disposed in front of the image sensor to block infrared light but pass visible light.

However, addition of an optical element, such as IR cut filter, to the lens module increases the number of optical elements, complicating assembly of the lens module and negatively affecting precision of lens module function.

What is needed, therefore, is an unitary composite lens and a lens module having same providing simplified assembly while maintaining optical precision.

### SUMMARY

A unitary composite lens includes a body and an optical filter embedded therein.

Advantages and novel features of the unitary composite lens and the lens module having same will become more apparent from the following detailed description when taken in conjunction with the accompanying drawings.

### BRIEF DESCRIPTION OF THE DRAWINGS

The components in the drawing are not necessarily drawn to scale, the emphasis instead being placed upon clearly illustrating the principles of the disclosure.

FIG. 1 is a cross-section of a lens module incorporating an unitary composite lens in accordance with a first exemplary embodiment.

FIG. 2 is a cross-section of a lens module incorporating an unitary composite lens in accordance with a second exemplary embodiment.

Corresponding reference characters indicate corresponding parts. The exemplifications set out herein illustrate at least one preferred embodiment of the unitary composite lens and the lens module having same, in one form, and such exemplifications are not to be construed as limiting the scope of the disclosure in any manner.

### DETAILED DESCRIPTION OF THE EMBODIMENT

Reference will now be made to the drawings to describe embodiments of the unitary composite lens and the lens module having same in detail.

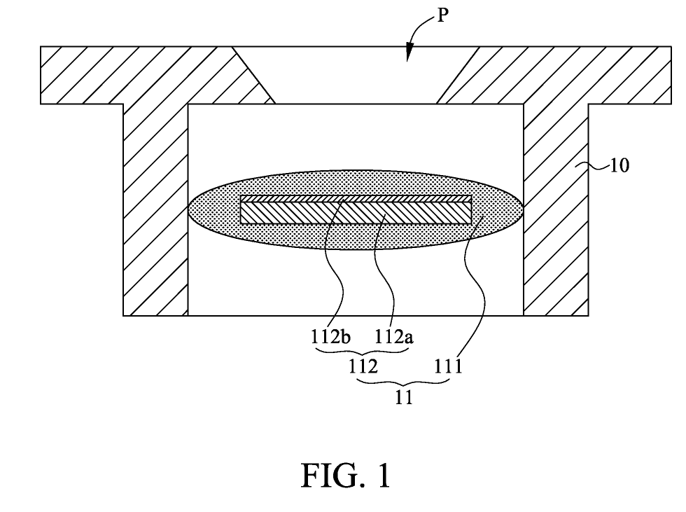

Referring to FIG. 1, a lens module 1 in accordance with an illustrated embodiment, includes a lens barrel 10 and a unitary composite lens 11. In the embodiment, the lens module 1 can be deployed in electronic devices such as notebook computers, personal digital assistants (PDAs), or cellular telephones.

The lens barrel 10 has a cylindrical body and a front end joined thereto. An opening P is defined at the front end thereof, through which light enters the body. The cylindrical body defines an inner space accommodating the unitary composite lens 11. The light passes through the unitary composite lens 11 and converges on a sensor (not shown in FIG. 1). The sensor can be a solid-state sensor such as a charge-coupled device (CCD) or a complementary metal-oxide-semiconductor (CMOS).

The unitary composite lens 11 includes a body 111 and an optical filter 112 embedded therein. In the embodiment, the body 111 is plastic and covers the optical filter 112 entirely, by means of conventional injection-molding practice. The surface of the body 111 can be spherical or non-spherical.

The optical filter 112 includes a substrate 112a and a first filter film 112b disposed on a surface of the substrate 112a. The substrate 112a is transparent material such as glass. In the embodiment, the first filter film 112b is an infrared cut filter, which blocks the transmission of the infrared light while passing the visible light. The first filter film 112b consists of alternating stacked high- and low-reflective films. The high-reflective film can be titanium dioxide (TiO₂), niobium pentoxide (Nb₂O₅) or tantalum pentaoxide (Ta₂O₅). In addition, the low-reflective film is silicon dioxide (SiO₂).

In practice, injection molding is utilized to form the unitary composite lens 11. A mold inversing the contours and features of the product, i.e. the unitary composite lens is firstly provided. The optical filter 112 is fastened to the mold and the mold is closed. Material for body 111 of the unitary composite lens 11, such as, molten plastic, is injected at high pressure into the mold. As a result, the optical filter 112 is embedded in the body 111, forming the unitary composite lens 11.

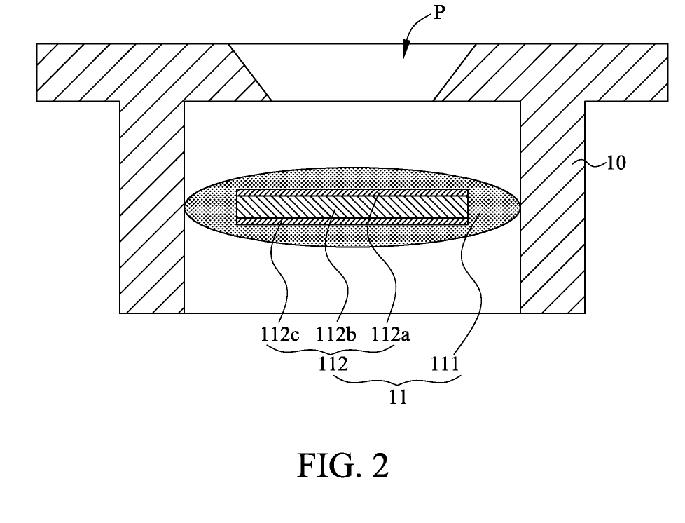

Referring to FIG. 2, the optical filter 11 of the illustrated embodiment can further include a second filter film 112c, disposed on an opposite surface of the substrate 112b from the first filter film 112a. Thus, stress between the substrate 112b and the filter films 112a, 112c is balanced, and deflection of the optical filter 11 and resulting optical aberration is avoided. In the embodiment, the second filter film 112c also can be an infrared cut filter.

In conclusion, by integrating the optical filter with the lens to form a unitary composite lens, the number of optical elements are reduced. When the unitary composite lens is to be installed in the lens module, assembly is simplified, as is resulting efficiency of process.

Finally, it is to be understood that the described embodiments are intended to illustrate rather than limit the disclosure. Variations may be made to the embodiments without departing from the spirit of the disclosure as claimed. The above-described embodiments illustrate the scope of the disclosure but do not restrict the scope of the disclosure.

What is claimed is:

1. A unitary composite lens comprising:
a body; and
an optical filter embedded within the body.

2. The unitary composite lens as claimed in claim 1, wherein the optical filter is formed integrally with the body.

3. The unitary composite lens as claimed in claim 1, wherein the optical filter comprises a substrate and a first filter film on the substrate.

4. The unitary composite lens as claimed in claim 3, wherein the optical filter further comprises a second filter film on an opposite surface of the substrate to the first filter film.

5. The unitary composite lens as claimed in claim 3, wherein the first filter film is an infrared cut filter.

6. The unitary composite lens as claimed in claim 4, wherein the second filter film is an infrared cut filter.

7. The unitary composite lens as claimed in claim 1, wherein the body is comprised of plastic material.

8. A lens module comprising:
a lens barrel; and
a unitary composite lens accommodated within the lens barrel, the unitary composite lens comprising a body and an optical filter embedded within the body.

9. The lens module as claimed in claim 8, wherein the optical filter is formed integrally with the body.

10. The lens module as claimed in claim 8, wherein the optical filter comprises a substrate and a first filter film on the substrate.

11. The lens module as claimed in claim 10, wherein the optical filter further comprises a second filter film on an opposite surface of the substrate to the first filter film.

12. The lens module as claimed in claim 10, wherein the first filter film is an infrared cut filter.

13. The lens module as claimed in claim 11, wherein the second filter film is an infrared cut filter.

14. The lens module as claimed in claim 8, wherein the body is comprised of plastic material.
